(19) United States
(12) Patent Application Publication
(10) Pub. No.: US 2003/0048512 A1
(43) Pub. Date: Mar. 13, 2003

(54) Optical transceiver and transmission media converter

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/236,635

(22) Filed: Sep. 6, 2002

(30) Foreign Application Priority Data
Sep. 10, 2001 (JP) 2001-272871

(51) Int. Cl. H04B 10/00

(52) U.S. Cl. 359/152; 359/163

(57) ABSTRACT

An optical transceiver that does not transmit optical signals during an idle period and is capable of preventing harm to the human eye even when an optical fiber connected to the transceiver is disconnected. The optical transceiver also facilitates detecting when a disconnected optical fiber has been reconnected. The optical transceiver transmits a link signal in the form of intermittent pulses when no transmission data is available, a first dummy signal when no signal is received from the opposing optical transceiver, a second dummy signal when a first dummy signal is received, and a normal signal including a link signal when either a link signal or a packet is received.

### BACKGROUND OF THE INVENTION

1. Field of the Invention

The present invention relates to an optical transceiver in an optical transmission system that employs optical fibers. The present invention also relates to an eye-safe mechanism for preventing the harmful effects on humans of laser light emitted from the optical transceiver. Furthermore, the present invention relates to an eye-safe mechanism applied to a point-to-point optical communication method that does not transmit idle signals when valid data signals are not present, in order to save energy and extend the life of the light source.

2. Description of the Related Art

FIG. 7 is a conceptual diagram showing a conventional fiber optic communication system. As shown in FIG. 7(a), an optical signal 105 is transmitted from an optical transceiver 101 along an optical fiber 103 to an optical transceiver 102. Similarly an optical signal 106 from the optical transceiver 102 is transmitted along an optical fiber 104 to the optical transceiver 101. This type of optical transmission system is called a point-to-point method.

FIG. 7(b) shows the configuration of optical signal transmission data employed in the point-to-point optical fiber communications system shown in FIG. 7(a). When valid data 112 and 114 are not present, idle signals 111 and 113 are transmitted. In other words, some type of optical signal is constantly exchanged between the optical transceiver 101 and the optical transceiver 102 during normal operations.

No problems will occur in the above process while the optical transceivers are properly connected by optical fibers. However, when an optical transceiver is not connected to an optical fiber, laser light from the optical transceiver is emitted into free space and can be harmful to the human eye. In order to avoid this adverse effect, optical transceivers have been designed to restrict the intensity of laser light emitted therefrom in order that the laser light is not harmful to the human eye even when emitted into free space. The conditions for preventing harm to the health of human eyes are called eye-safe conditions, while a mechanism for preventing the harmful effects on eyes is called an eye-safe mechanism. However, as the transmission bit rate of optical signals increases, it is necessary to use a larger intensity of laser light, or else the optical signal will be attenuated while being transferred along the optical fiber over a long distance and a correct signal cannot be received properly on the other end. Further, with the popularization of wavelength multiplexing technology, the problem of eye protection becomes even more important. In wavelength multiplexing technology, a plurality of optical signals having different wavelengths is combined on a single optical fiber. Hence, while individual optical signals may satisfy eye-safe conditions, these same eye-safe conditions may no longer be met when a plurality of such optical signals is combined.

In order to resolve these issues, an eye-safe mechanism was proposed in Japanese Published Unexamined Patent Application 2001-217778. This mechanism is designed for use in an optical transceiver that constantly outputs an idle signal when no valid data signal is present and comprises a mechanism for automatically recovering from a disconnection after the connection is restored. The mechanism accomplished this by transmitting a dummy signal when no optical signal is received from the opposing end.

FIG. 8 shows this type of conventional apparatus. As shown in FIG. 8, optical transceivers 121 and 122 are configured to transmit a normal signal N when an optical signal is received from the opposing end and to transmit a dummy signal D when no optical signal is received from the opposing end. When the optical transceivers 121 and 122 are properly connected to each optical fibers 124 and 124, as shown in FIG. 8(a), the optical transceivers 121 and 122 transmit a normal signal N. When optical fibers 123 and 124 connecting the optical transceivers 121 and 122 become disconnected, as shown in FIG. 8(b), a dummy signal D is transmitted. The dummy signal D is designed to have a lower optical intensity than the normal signal N, so as not to be harmful to the human eye. When the optical fibers 123 and 124 are reconnected, as shown in FIG. 8(c), the transmitted signal shifts from the dummy signal D to the normal signal N. With this configuration, the optical transceivers 121 and 122 can automatically recover when the connection is restored.

The optical transceiver described in Japanese Published Unexamined Patent Application 2001-217778 is based on the principle that an idle signal is transmitted when no valid data signal is present. However, it is preferable not to transmit an idle signal even when a valid data signal is not present, in order to save energy and extend the lifespan of the light source.

FIG. 9 shows the signal transmission method which does not use an idle signal. In this transmission format, the conventional method described in Japanese Published Unexamined Patent Application 2001-217778 is not applicable. This is because the conventional optical transceiver in Japanese Published Unexamined Patent Application 2001-217778 determines whether to transmit a dummy signal based on the existence of an optical signal received from the opposing end. In the signal transmission format of FIG. 9, however, there also exists periods when an optical signal is not received, even in a properly connected state.

### SUMMARY OF THE INVENTION

In view of the foregoing, it is an object of the present invention to provide an optical transceiver that does not transmit optical signals during an idle period and is capable of preventing harm to the human eye even when an optical fiber connected to the transceiver is disconnected. It is another object of the present invention to provide an optical transceiver that can easily detect when a disconnected optical fiber has been reconnected.

These objects and others will be attained by an optical transceiver of the present invention comprising a function for transmitting a link signal L when no transmission data exists, the link signal L being formed of repeated intermittent pulses at a prescribed period H3; a function for transmitting transmission data as a normal signal N after adding a preamble of prescribed length when transmission data exists; a function for transmitting a first dummy signal S1 during a state O when no signals are received, the first dummy signal S1 being formed of repeated intermittent pulses at a prescribed period H1; a function for transmitting a second dummy signal S2 when the first dummy signal S1 is being received, the second dummy signal being formed of repeated intermittent pulses at a prescribed period H2; a function for transmitting a normal signal N when the second dummy signal S2 is detected; a function for transmitting a normal signal N when a link signal is detected; and a function for transmitting a normal signal N when a normal signal N has been received.

With this configuration, a link signal is transmitted even when transmission data (packets) does not exist. Hence, the transceivers according to the present invention can detect the connection status based on the link signal. Since the first and second dummy signals are transmitted intermittently, the average output over time is sufficiently reduced, thereby preventing harmful effects on human eyes, even when light received from an optical transceiver is emitted externally. The average intensity of the link signal over time is also sufficiently reduced, enabling the present invention to save energy and extend the life of the light source.

The above aspects and others of the present invention defined in the scope of the claims will be described in more detail in the embodiments below.

### BRIEF DESCRIPTION OF THE DRAWINGS

In the drawings:

FIG. 1 is a block diagram showing a media converter according to a first embodiment of the present invention;

FIG. 2 is a block diagram showing the internal construction of the preamble adding circuit 2 in FIG. 1;

FIG. 3 is a timing chart showing the operations of the preamble adding circuit 2 in FIG. 1;

FIG. 4 is a block diagram showing the internal construction of the optical transceiver in FIG. 1;

FIG. 5 includes explanatory diagrams illustrating the operations over time of an optical transceiver module of the present invention;

FIG. 6 is a block diagram showing the construction of a preamble adding circuit and eye-safe interlock mechanism combined on a single integrated circuit;

FIG. 7 includes explanatory diagrams showing the point-to-point communication format and the signal pattern of that format;

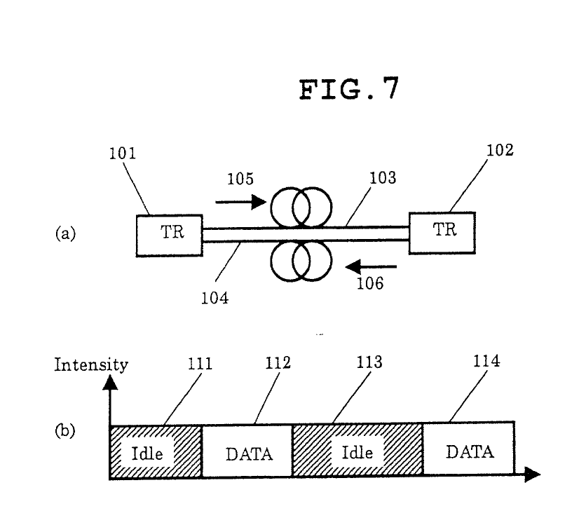

FIG. 8 includes explanatory diagrams showing the operations of a conventional eye-safe interlock mechanism; and

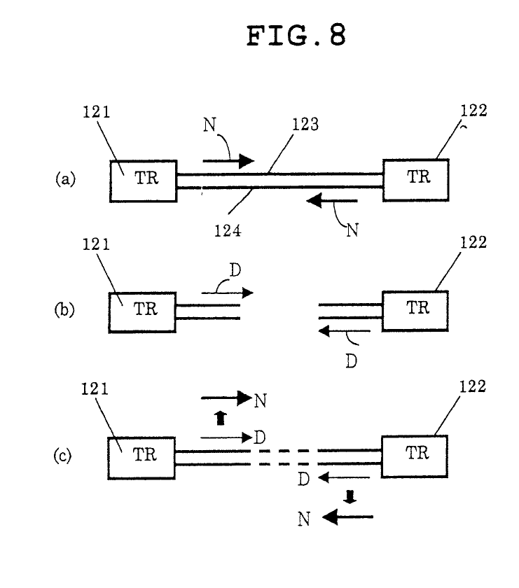

FIG. 9 is an explanatory diagram showing the signal pattern in a point-to-point format that does not transmit optical signals during an idle period.

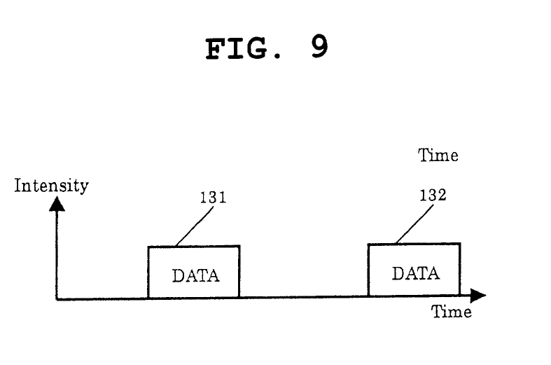

### DESCRIPTION OF THE PREFERRED EMBODIMENTS

An optical transceiver according to preferred embodiments of the present invention will be described while referring to the accompanying drawings.

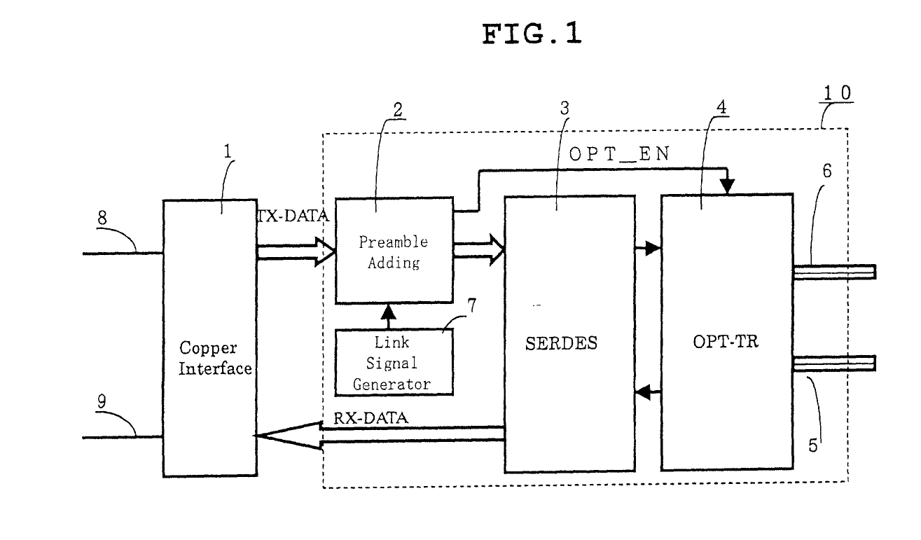

FIG. 1 shows an optical transceiver module 10 according to a first embodiment of the present invention. A copper cable interface 1 outputs transmission data (Tx data) to the optical transceiver module 10 using a 10-bit parallel FC-0 interlace, for example. A preamble adding circuit 2 adds a preamble to the transmission data. A link signal generator 7 also adds a signal to the preamble adding circuit 2. A serializer/deserializer (SerDes) 3 converts the parallel signals to a serial signal and an optical transceiver 4 converts the serial signal to an optical signal. Subsequently, the optical signal is transmitted along an optical fiber 6. Optical signals received along an optical fiber 5 pass through the optical transceiver 4 and the SerDes 3 to be deserialized into parallel signals (Rx data). The parallel signals are transmitted to the copper cable interface 1. The copper cable interface 1 transmits and receives signals via copper cables 8 and 9. In the present embodiment, a media converter comprises the optical transceiver module 10 and the copper cable interface 1.

The copper cables in the present embodiment conform to 1000 BaseT, a standard used for Gigabit Ethernet twisted pair cables. Optical signals are transmitted after being encoded in the 8B/10B encryption scheme. The 100 BaseT standard, also called Fast Ethernet, can also be applied to the copper cables to transmit optical signals encoded in the 4B/5B encryption scheme. It is also possible to perform what is known as single-cable bi-directional communications using an optical fiber coupler or WDM optical fiber coupler in place of the optical fibers 5 and 6.

The preamble adding circuit 2 uses a first-in first-out (FIFO) memory to delay data transmitted from the copper cable interface 1 for a prescribed time period. During this time delay, the preamble adding circuit 2 inserts a header (preamble) into the data.

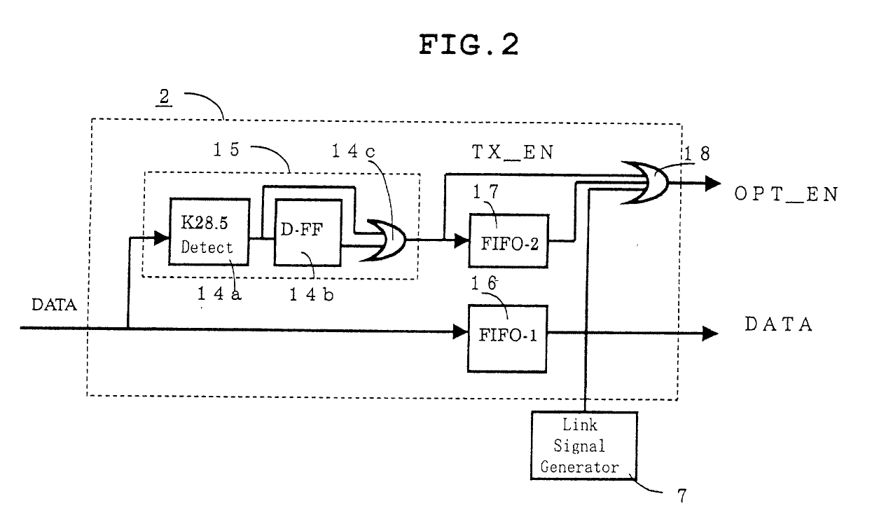

FIG. 2 shows the internal construction of the preamble adding circuit 2. The preamble adding circuit 2 comprises an idle signal detection circuit 15, first-in first-out (FIFO) memories 16 and 17, and an OR gate 18.

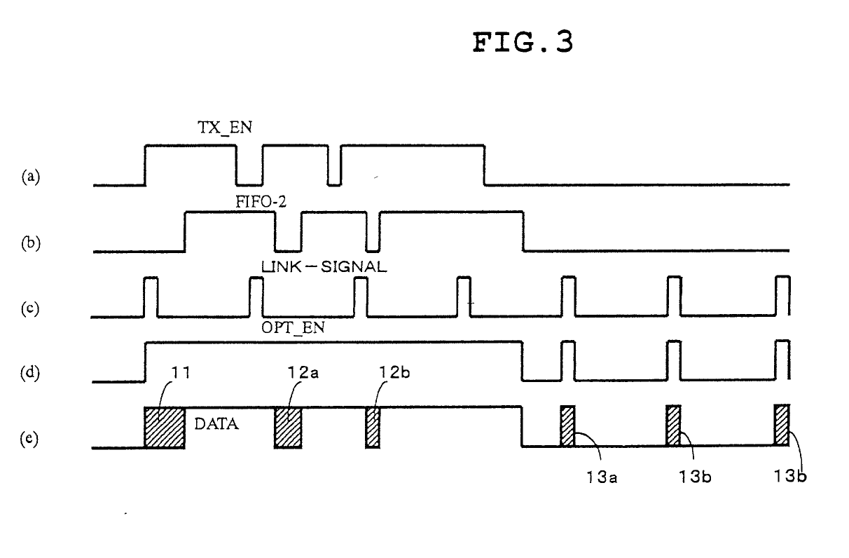

FIG. 3 is a timing chart showing the operations of the preamble adding circuit 2 in FIG. 2. Here, 10-bit parallel data (FC-0) is transmitted to the first FIFO 16, while a Tx-EN signal generated by the idle signal detection circuit 15 is transmitted to the second FIFO 17. The first-in first-out memories 16 and 17 function as delay circuits and are set at the same depth.

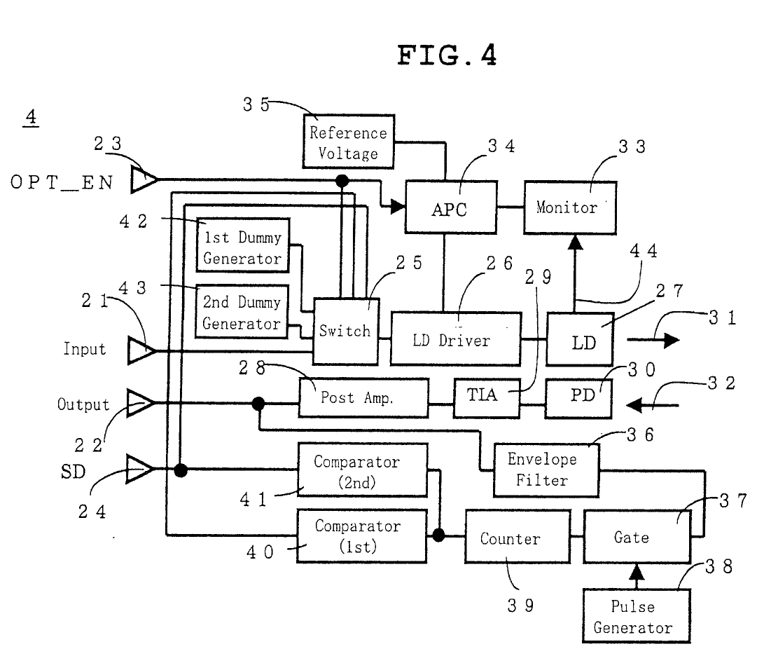

The preamble adding circuit 2 can also be provided with a down counter proposed in Japanese Published Unexamined Patent Application 2001-156763 and shown in FIG. 4. This counter prevents an inappropriate preamble from being added due to the relationship between the lengths of the preamble and the packet.

The idle signal detection circuit 15 detects an idle signal, a two-word repeated signal formed of a one-word K28.5 signal and one-word of a prescribed data). A state in which an idle signal is not detected is a state in which transmission data exists (Tx-EN). The idle signal detection circuit 15 comprises a K28.5 signal detecting circuit 14a, a D-flipflop (delay circuit) 14b, and an OR gate 14c. This is the idle circuit detection circuit used for the 8B/10B encryption scheme. The circuit can be modified to suit the idle signal in a different encryption scheme, such as the 4B/5B encryption code.

FIG. 3(a) shows the Tx_EN signal, while FIG. 3(b) shows the output from the second FIFO 17. Here you can see the delay generated in the second signal. FIG. 3(d) is an OPT_EN signal, enabling transmission of the optical transceiver 4. This OPT_EN signal is derived from the logical sum of the TX_EN signal, the output from the second FIFO 17, and the link signal transmitted from the link signal generator 7 by OR gate 18. The OPT_EN signal controls the opening and closing of a switch 25 in the optical transceiver 4. FIG. 3(c) shows the waveform of the link signal generated by the link signal generator 7. The link signal is set to approximately the same period as a dummy signal S2, described later. The OPT_EN signal shown by FIG. 3(d) is transmitted to the optical transceiver 4. The optical transceiver 4 transmits an optical signal only when the OPT_EN signal is high.

The copper cable interface 1 constantly transmits an idle signal when no data signal is present. Accordingly, the first FIFO 16 delays the data signal transmitted from the copper cable interface 1, while an idle signal already stored in the first FIFO 16 is output during this delay period. After the prescribed time period has elapsed, the actual data is output from the first FIFO 16. FIG. 3(e) shows the output from the SerDes 3. Due to the operations of the preamble adding circuit 2 described above, a preamble 11 formed of an idle signal is added in front of the data encoded in the 8B/10B encryption scheme. The preamble 11 is required to synchronize a phase-locked loop (PLL) provided in the SerDes 3. If the packet data continues for only short intervals, idle signals 12a and 12b are inserted and transmitted between data packets. Further, if no data is transmitted for a long time period, link signals 13a, 13b, and 13c are outputted. The link signals 13a, 13b, and 13c are formed to maintain the idle signals for a prescribed time. The period of the idle signals is set to 1 KHz, which is approximately the same as the dummy signal S2 described later.

FIG. 4 is a block diagram showing the optical transceiver 4. An electric signal from the SerDes 3 is applied to an input terminal 21. The input signal passes through a signal switch 25 and a laser driver 26 to drive a semiconductor laser 27. A laser light (optical signal) 31 emitted from the semiconductor laser 27 is modulated according to the electric signal applied to the input terminal 21. A first dummy signal generator 42 and a second dummy signal generator 43 are connected to the switch 25. As is described later, signals from the dummy signal generators 42 and 43 are transmitted as the optical signal 31 in place of the signal from the input terminal 21 when a normal optical signal (link signal) is not detected from the opposing optical transceiver. Here, the frequency of the signal emitted from the dummy signal generators 42 and 43 is selected to be sufficiently lower than the frequency of a normal optical signal. For example, when a normal optical signal is 1 Gbit/sec, the first dummy signal S1 emitted from the first dummy signal generator 42 is set to 2 KHz, while the second dummy signal S2 emitted from the second dummy signal generator 43 is set to 1 KHz.

In this case, the first dummy signal S1 is set to a higher frequency than the second dummy signal S2.

On the other hand, an optical signal 32 sent from the opposing optical transceiver via an optical fiber is converted from an optical signal to an electrical current signal by an optical sensing element (photodiode) 30. This current signal is converted to a voltage signal by a transimpedance amplifier 29. The voltage signal is subsequently converted to a digital electric signal by a post-amplifier 28 having a waveform shaping function and output from an output terminal 22. The signal is transmitted to the SerDes 3.

A portion 44 of the optical signal output from the semiconductor laser 27 is transferred to a monitor optical sensor (photodiode) 33, where it is converted from an optical to an electrical signal and sent to an automatic power controller 34. The automatic power controller 34 compares the signal with a reference voltage 35 and adjusts the transmitted optical signal intensity to a fixed value. The laser driver 26 amplifies the signal received from the switch 25 to drive the semiconductor laser 27. The automatic power controller 34 is a digital power controller. An OPT_EN signal 23 is applied to the automatic power controller 34. The automatic power controller 34 only regulates output when the OPT_EN signal is high. The automatic power controller 34 is also provided with a mechanism for storing the optical control status (refer to Japanese Published Unexamined Patent Application 2001-156718). This mechanism is desirable for adjusting the optical intensity of an optical transceiver not transmitting an idle signal. However, it is possible to stabilize optical intensity without this type of mechanism by providing the preamble is sufficiently long.

Output from the post-amplifier 28 passes through an envelope filter 36 and a gate 37 and is applied to a counter 39. The gate 37 is opened and closed according to output from the envelope filter 36. The counter 39 counts signals received from a pulse generator 38. With this configuration, the counter 39 indicates the envelope period of the received signal.

A digital comparator 40 for detecting the first dummy signal S1 and a digital comparator 41 for detecting the second dummy signal S2 compare the count value from the counter 39 to a preset number in order to detect the first dummy signal and the second dummy signal (link signal). The comparator 40 detects the first dummy signal S1 when the frequency is higher than 1.5 KHz, while the comparator 41 detects the second dummy signal S2, or a normal signal containing the link signal, when the frequency is lower than 1.5 KHz.

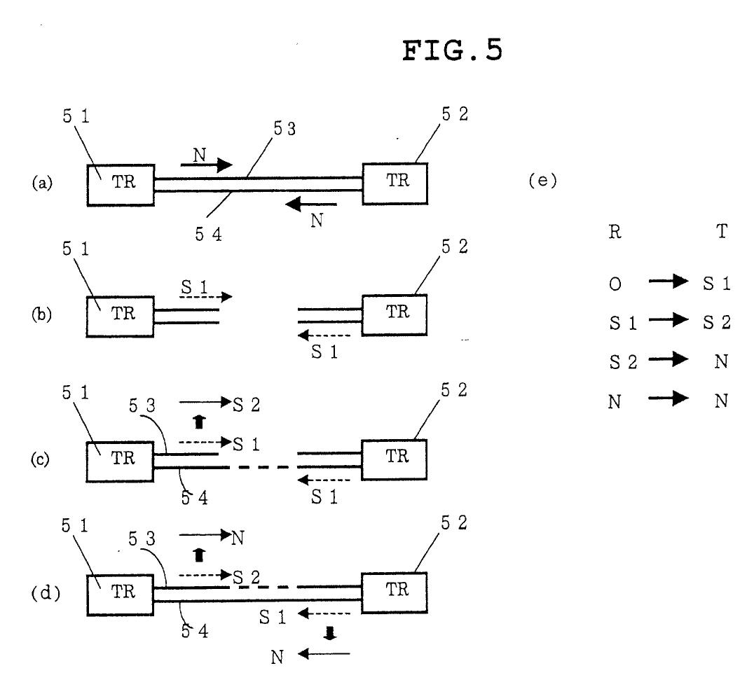

FIG. 5 shows interconnected optical transceivers 51 and 52 having the construction shown in FIG. 4. FIG. 5(a) shows the state of the two optical transceivers 51 and 52 when properly connected by optical fibers 53 and 54. FIG. 5(b) shows the state of the optical transceivers 51 and 52 when the connection between them has broken. FIG. 5(c) shows the very instant that the single optical fiber 54 alone is reconnected between the optical transceivers 51 and 52. FIG. 5(d) shows the very instant when the other optical fiber 53 is reconnected, while the optical fiber 54 is still connected between the optical transceivers 51 and 52. FIG. 5(e) shows the behavior of the optical transceivers 51 and 52. When no signal is being received (O), the transceiver transmits the first dummy signal S1 (a 2 KHz signal). When the first dummy signal S1 is received, the transceiver transmits the second dummy signal S2 (a 1 KHz signal). When the second dummy signal S2 is received, the transceiver transmits a normal optical signal N (an 8B/10B encryption or a link signal at 1 Gbps). When a normal signal N is received, the transceiver transmits a normal signal N.

The present embodiment employs a format for never transmitting idle signals between data packets. However, a link signal is transmitted at a 1-KHz period between these data packets. Accordingly, a signal equivalent to the second dummy signal S2 is detected. The switch 25 is controlled to open when any of the dummy signal S2, normal packet signal, or link signal is detected. More precisely, the switch 25 is opened when a prescribed logical interpretation is received based on the OPT_EN signal, the output from the digital comparator 40, and the output from the digital comparator 41. Further, the output from the digital comparator 41 is connected to a signal detector 24. Ordinarily, signal detection is performed through detection of a normal signal N. However, the above configuration is employed in the present invention since the digital comparator 41 also performs detection of a link signal.

When the optical transceivers 51 and 52 are properly connected, they transfer normal optical signals (1 Gbps) in a high-output mode (+6 dBm). However, when an optical fiber becomes disconnected and one transceiver does not receive a signal from the other transceiver, the first transceiver switches to a low-output mode (−6 dBm) that is safe for the human eye and transmits the low-speed dummy signal S1 (2 KHz) in place of the normal optical signal N. Here, the low-intensity light is transmitted instead of no optical signal in order that the transceivers can detect when a connection between them has been restored. If optical signals are completely blocked, a reconnection cannot be detected.

However, if a normal signal is transmitted upon receiving a dummy signal S1, a signal of normal intensity passes from the optical transceiver 51 through the optical fiber 53 and is emitted into free space when only one of the optical fibers is connected, as shown in FIG. 5(c). To resolve this problem, the present embodiment provides two types of dummy signals. In the case shown in FIG. 5(c), the optical transceiver 51 transmits the second dummy signal S2 because the optical transceiver 51 has received the first dummy signal S1. However, since the other optical transceiver 52 has not received any signal (O), the optical transceiver 52 continues to transmit the dummy signal S1.

When the other optical fiber 53 is reconnected, as shown in FIG. 5(d), the optical transceiver 52 receives the dummy signal S2 and begins to transmit a normal signal N. After receiving the normal signal N from the optical transceiver 52, the optical transceiver 51 also begins to transmit a normal signal N.

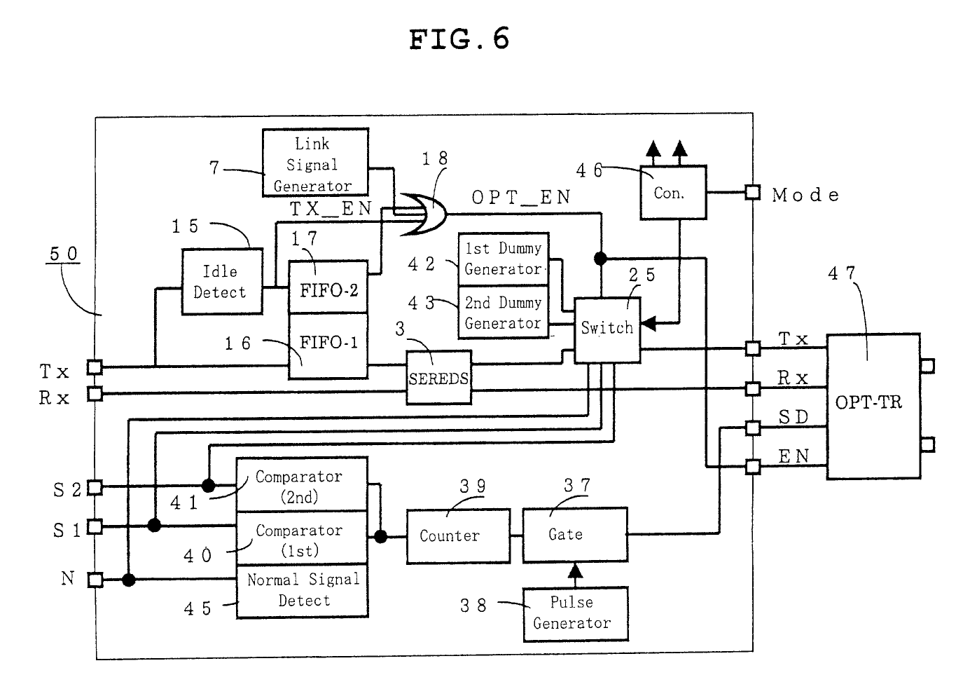

FIG. 6 shows a second embodiment of the present invention. In the second embodiment, the preamble adding circuit, an eye-safe interlock mechanism, and the like are configured in a single integrated circuit 50. A parallel signal is applied to the integrated circuit 50 via a copper cable interface or the like (not shown). The integrated circuit 50 is connected to an optical transceiver 47. The optical transceiver 47 is provided with an input terminal for a transmission signal (Tx), an output terminal for a reception signal (Rx), a signal detection (SD) terminal, and a transmission enable terminal (EN).

The present embodiment eliminates the envelope filter 36 of the first embodiment and detects the envelope using an optical transceiver signal detection signal. The integrated circuit 50 is also provided with a normal signal detecting circuit 45 and a control circuit 46.

The operations of the integrated circuit 50 are similar to those of the preamble addition circuit and eye-safe interlock mechanism described above and will be omitted here. In the present embodiment, the preamble addition circuit and eye-safe interlock mechanism are configured on a single chip and can be connected and used with an existing optical transceiver.

Further, a mode terminal input can be used to switch operations of the control circuit 46, thereby disabling the preamble addition or enabling the eye-safe interlock when an idle signal is continually transmitted during an idle period.

Of course, the envelope filter 36 can be provided in the integrated circuit 50. The circuit can also be designed to select a mode based on the control circuit 46 to generate an envelope from either the Rx signal or the SD signal. It is also possible to provide a mode for constantly transmitting a low signal to the Tx input when there is no transmission enable terminal (EN). Since some optical transceivers on the market do not include either the signal detector (SD) terminal or the transmission enable terminal (EN).

The preamble addition time of the circuit can also be made variable. In optical transceivers that do not have a digital automatic power control circuit, it is sometimes necessary to stabilize the laser intensity by applying a sufficiently long preamble.

The circuit can also be configured based on an externally loaded program to change sequences of preamble addition, dummy signal generation, and the like, rather than simply switching modes.

The optical transceiver of the present invention described above is used for point-to-point optical transmission and is designed to stop sending optical signal during an idle period, thereby preventing harm to the human eye caused by laser light being emitted into free space when the optical fiber is disconnected. The optical transceiver can restore itself automatically to a normal transmission state when the optical fibers are reconnected. The optical transceiver according to the present invention saves energy and extends the life of the transceiver by stopping transmission of optical signals during an idle period.

What is claimed is:

1. An optical transceiver for use in a point-to-point optical communication system connected by optical fibers, comprising:
means for transmitting a link signal L when no transmission data exists, the link signal L being formed of repeated intermittent pulses at a prescribed period H3;
means for transmitting transmission data as a normal signal N after adding a preamble of prescribed length when transmission data exists;
means for transmitting a first dummy signal S1 during a state O when no signals are received, the first dummy signal S1 being formed of repeated intermittent pulses at a prescribed period H1;
means for transmitting a second dummy signal S2 when the first dummy signal S1 is being received, the second dummy signal being formed of repeated intermittent pulses at a prescribed period H2;
means for transmitting a normal signal N when the second dummy signal S2 is detected;
means for transmitting a normal signal N when a link signal is detected; and
means for transmitting a normal signal N when a normal signal N has been received.

2. An optical transceiver as recited in claim 1, wherein the period H3 of the link signal is substantially the same as the period H2 of the second dummy signal S2.

3. A media converter comprising:
(a) an optical transceiver for use in a point-to-point optical communication system connected by optical fibers, the optical transceiver comprising:
means for transmitting a link signal L when no transmission data exists, the link signal L being formed of repeated intermittent pulses at a prescribed period H3;
means for transmitting transmission data as a normal signal N after adding a preamble of prescribed length when transmission data exists;
means for transmitting a first dummy signal S1 during a state O when no signals are received, the first dummy signal S1 being formed of repeated intermittent pulses at a prescribed period H1;
means for transmitting a second dummy signal S2 when the first dummy signal S1 is being received, the second dummy signal being formed of repeated intermittent pulses at a prescribed period H2;
means for transmitting a normal signal N when the second dummy signal S2 is detected;
means for transmitting a normal signal N when a link signal is detected; and
means for transmitting a normal signal N when a normal signal N has been received; and
(b) a copper cable interface.

4. An integrated circuit for connecting with an optical transceiver, comprising at least a dummy signal generating circuit, a dummy signal detecting circuit, and a dummy signal generation sequence controlling mechanism.

5. An integrated circuit as recited in claim 4, further comprising a preamble adding circuit.

6. An integrated circuit as recited in claim 4, wherein the dummy signal generation sequence is modified by a mode control signal added externally.

7. An integrated circuit as recited in claim 5, wherein the preamble adding sequence is modified by a mode control signal added externally.

8. An integrated circuit as recited in claim 4, further comprising a mechanism for loading a program externally, wherein the dummy signal generation sequence is modified by the loaded program.

9. An integrated circuit as recited in claim 5, further comprising a mechanism for loading a program externally, wherein the preamble adding sequence is modified by the loaded program.

10. An optical transceiver for use in a point-to-point optical communication system connected by optical fibers, comprising:
means for transmitting a link signal L when no transmission data exists, the link signal L being formed of repeated intermittent pulses at a prescribed period H3;
means for transmitting transmission data as a normal signal N after adding a preamble of prescribed length when transmission data exists; and
means for transmitting a dummy signal controlled at an output intensity that is not harmful to the human eye, while neither a link signal nor a normal signal is being received.
